(19) United States
(12) Patent Application Publication
(10) Pub. No.: US 2017/0115665 A1
(43) Pub. Date: Apr. 27, 2017

(54) THERMAL STEREO PERCEPTION SYSTEM

(71) Applicant: Caterpillar Inc., Peoria, IL (US)

(72) Inventors: Qi Wang, Pittsburgh, PA (US); Joseph Edward Forcash, Zelienople, PA (US)

(73) Assignee: CATERPILLAR INC., Peoria, IL (US)

(21) Appl. No.: 14/924,285

(22) Filed: Oct. 27, 2015

(51) Int. Cl. G05D 1/02; G01J 5/10; B60W 10/20; B60W 30/18; B60W 10/04; B60W 10/18

(52) U.S. Cl. CPC G05D 1/0238; B60W 10/04; B60W 10/18; B60W 10/20; B60W 30/18; G01J 5/10; B60W 2300/125; B60W 2300/17; B60W 2420/42; G01J 2005/0081

(57) ABSTRACT

A perception system for a work machine may include a short-range thermal stereo detector and a long-range thermal stereo detector both mounted to the work machine. The long-range thermal stereo detector may face in the same direction as the short-range thermal stereo detector. The perception system may also include a controller associated with the short-range thermal stereo detector and the long-range thermal stereo detector. The controller may be configured to receive information from both the short-range thermal stereo detector and the long-range thermal stereo detector and may also be configured to process the information for displaying on an output device of the work machine or for automatically controlling, based on the information processed, components mechanically associated with the work machine.

### TECHNICAL FIELD

The present disclosure relates generally to thermal stereo perception systems and, more particularly, to a thermal stereo perception system for a work machine.

### BACKGROUND

Many work machines in the earthmoving, industrial, and agricultural industries sometimes operate in harsh off-road environments and under poor visibility and environmental conditions. For example, at some work sites such as, but not limited to, mining and construction sites, the ground surface is often times uneven and may include obstacles such as berms, other machines, and personnel, which need to be safely navigated around or over. Such work sites may also experience poor visibility and environmental conditions like dust, fog, rain, snow, and low light, among other things, adding more difficulties in navigating the work site. Other work machines such as, but not limited to, large mining trucks, sometimes travel at high speeds to and from the work site under poor visibility and environmental conditions, but operate at lower speeds at the work site.

United States Patent Application Publication No. 2006/0018513 (the '513 publication) discloses a stereo vehicle-exterior monitoring apparatus. The stereo vehicle-exterior monitoring apparatus of the '513 publication is directed to on-road vehicles and is limited to improving night driving only. While effective, the '513 publication fails to disclose an apparatus capable of overcoming harsh off-road environments and poor visibility and environmental conditions other than low light conditions.

### SUMMARY

In accordance with an aspect of the disclosure, a perception system for a work machine is provided. The perception system may include a short-range thermal stereo detector and a long-range thermal stereo detector both mounted to the work machine. The long-range thermal stereo detector may face in the same direction as the short-range thermal stereo detector. The perception system may also include a controller associated with the short-range thermal stereo detector and the long-range thermal stereo detector. The controller may be configured to receive information from both the short-range thermal stereo detector and the long-range thermal stereo detector and may also be configured to process the information for displaying on an output device of the work machine or for automatically controlling, based on the information processed, components mechanically associated with the work machine.

In accordance with another aspect of the disclosure, a work machine is provided. The work machine may include a detection system mounted to the work machine. The detection system may include a short-range thermal stereo detector paired with a long-range thermal stereo detector. Components may be mechanically associated with the work machine. The work machine may also include a controller associated with the detection system and the components. The controller may be configured to receive information from both the short-range thermal stereo detector and the long-range thermal stereo detector. The controller may also be configured to process the information for displaying on an output device of the work machine or for automatically controlling the components based on the information processed.

In accordance with yet another aspect of the disclosure, a sample sequence of steps which may be performed for a work machine to perceive and detect, in poor visibility conditions, short-range and long-range environments is provided. The sample sequence of steps may entail providing a short-range thermal stereo detector and a long-range thermal stereo detector onto the work machine. Another step may be monitoring a short-range area pattern via the short-range thermal stereo detector. Yet another step may be monitoring a long-range area pattern via the long-range thermal stereo detector.

### BRIEF DESCRIPTION OF THE DRAWINGS

FIG. 1 is a perspective view of an exemplary work machine, in accordance with an embodiment of the present disclosure;

FIG. 2 is a schematic diagram illustrating an exemplary perception system, in accordance with an embodiment of the present disclosure;

FIG. 3 is a perspective view an exemplary detection system, in accordance with an embodiment of the present disclosure;

FIG. 4 is a diagram illustrating an exemplary monitored area pattern of the perception system, in accordance with an embodiment of the present disclosure;

FIG. 5 is a perspective view of an alternative embodiment of the perception system, in accordance with an embodiment of the present disclosure; and

FIG. 6 is a flow chart illustrating a sample sequence of steps which may be practiced in accordance with an embodiment of the present disclosure.

### DETAILED DESCRIPTION

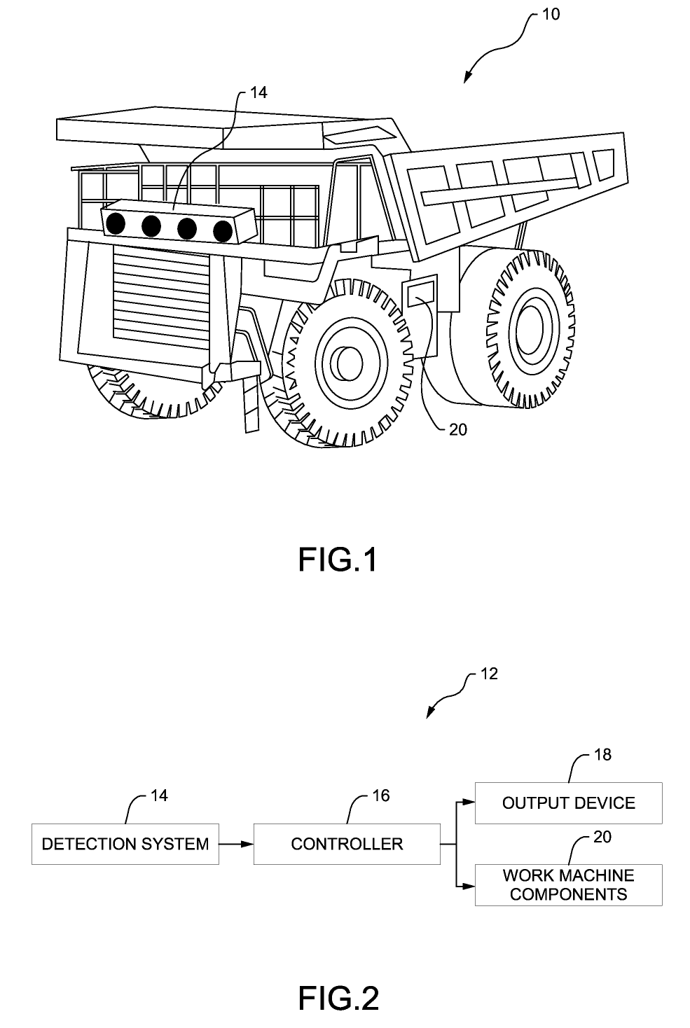

Referring now to FIG. 1, an exemplary work machine constructed in accordance with the present disclosure is generally referred to by reference numeral 10. While the work machine 10 is illustrated as a large mining truck, it is to be understood that the work machine may be any type of work machine well known in the earthmoving, industrial, and agricultural industries such as, but not limited to, excavators, motor graders, loaders, shovels, track-type tractors, pipelayers, compactors, dozers, scrapers, and the like. With reference to both FIGS. 1 and 2, the work machine 10 may include a perception system 12. The perception system 12 may be a thermal stereo perception system including a detection system 14, which may be mounted on-board the work machine 10, as depicted in FIG. 1. The perception system 12 may further include a controller 16 operatively associated with the detection system 14, an output device 18, and work machine components 20 mechanically associated with the work machine 10, as depicted in FIG. 2. The output device 18 may be, but is not limited to, a display.

The work machine 10 may be operated autonomously, semi-autonomously, or manually. For example, the work machine 10 may operate in an autonomous manner such that the work machine components 20, such as but not limited to, a steering device, brakes, a transmission, an engine, and the like, are controlled automatically based upon information monitored and provided by the detection system 14 and executed by the controller 16 without the need for human operator input. As another example, the work machine 10 may operate in a semi-autonomous manner such that an operator, who may be either on-board the work machine 10 or remotely located, performs some tasks or provides some input to control the work machine 10 while other tasks are performed automatically based upon information provided via the controller 16. As a further example, the work machine 10 may be operated manually such that an operator is controlling all or essentially all of the tasks and functions of the work machine 10.

The controller 16 may be any electronic controller or computing system including a processor which operates to perform operations, executes control algorithms, stores data, retrieves data, gathers data, and/or performs any other computing or controlling task or function desired. The controller 16 may be a single controller or may include more than one controller configured to control various functions and/or features of the work machine 10. Functionality of the controller 16 may be implemented in hardware and/or software. As such, the controller 16 may include internal memory and/or the controller may be otherwise connected to external memory, such as a database or server. The internal memory and/or external memory may include, but are not limited to including, one or more of read only memory (ROM), random access memory (RAM), a portable memory, and the like. Such memory media are examples of nontransitory memory media.

Furthermore, the controller 16 is operatively associated with the detection system 14 such that the controller 16 receives information from the detection system 14 to be processed for displaying on the output device 18 and/or providing instructions for controlling the work machine components 20.

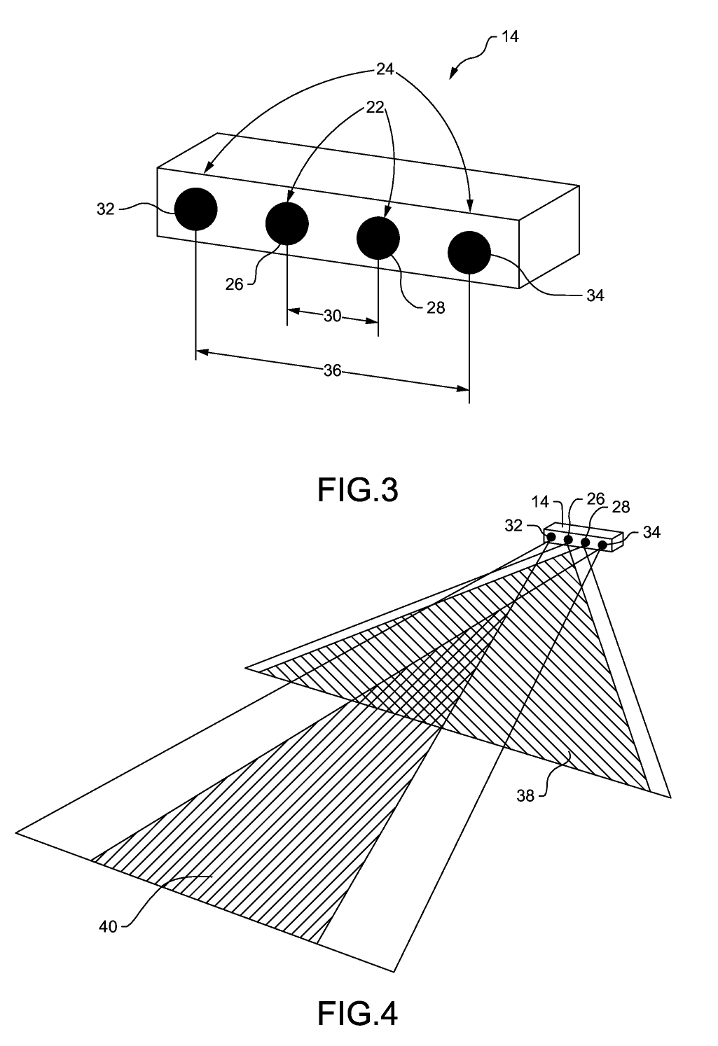

Referring to FIG. 3, the detection system 14 may include at least one short-range thermal stereo detector 22 paired with at least one long-range thermal stereo detector 24 facing in the same direction. The at least one short-range thermal stereo detector 22 may be coplanar with the at least one long-range thermal stereo detector 24 although other arrangements are within the scope of the present disclosure as well. The at least one short-range thermal stereo detector 22 includes short-range thermal sensors 26, 28 horizontally spaced apart from each other by a predetermined short-range stereo baseline 30. Similarly, the at least one long-range thermal stereo detector 24 includes long-range thermal sensors 32, 34 horizontally spaced apart from each other by a predetermined long-range stereo baseline 36. The short-range thermal sensors 26, 28 and the long-range thermal sensors 32,34 may be thermal cameras configured to detect long wavelength electromagnetic waves so as to perceive terrain gradients, personnel, and other objects, especially through difficult environmental conditions that create poor visibility such as, but not limited to, dust, fog, rain, and snow. Moreover, the short-range thermal sensors 26, 28 and the long-range thermal sensors 32, 34 are configured to operator in low-light environments as well, and as such do not rely on ambient light for detection.

With reference to both FIGS. 3 and 4, the predetermined short-range stereo baseline 30 may be preselected such that the at least one short-range thermal stereo detector 22 monitors a short-range area pattern 38. The short-range area pattern 38 may have, as a non-limiting example, a perception range from one meter to 20 meters away from the work machine 10 with a wide field of view. In a similar manner, the predetermined long-range stereo baseline 36 may be preselected such that the at least one long-range thermal stereo detector 24 monitors a long-range area pattern 40. The long-range area pattern 40 may have, as a non-limiting example, a perception range from 20 meters to 80 meters away from the work machine 10 or longer. Moreover, the predetermined short-range stereo baseline 30 may be preselected to be 10 centimeters or less and the predetermined long-range stereo baseline 36 may be preselected to be 10 centimeters or greater, although both baselines 30, 36 may certainly be preselected from other ranges as desired.

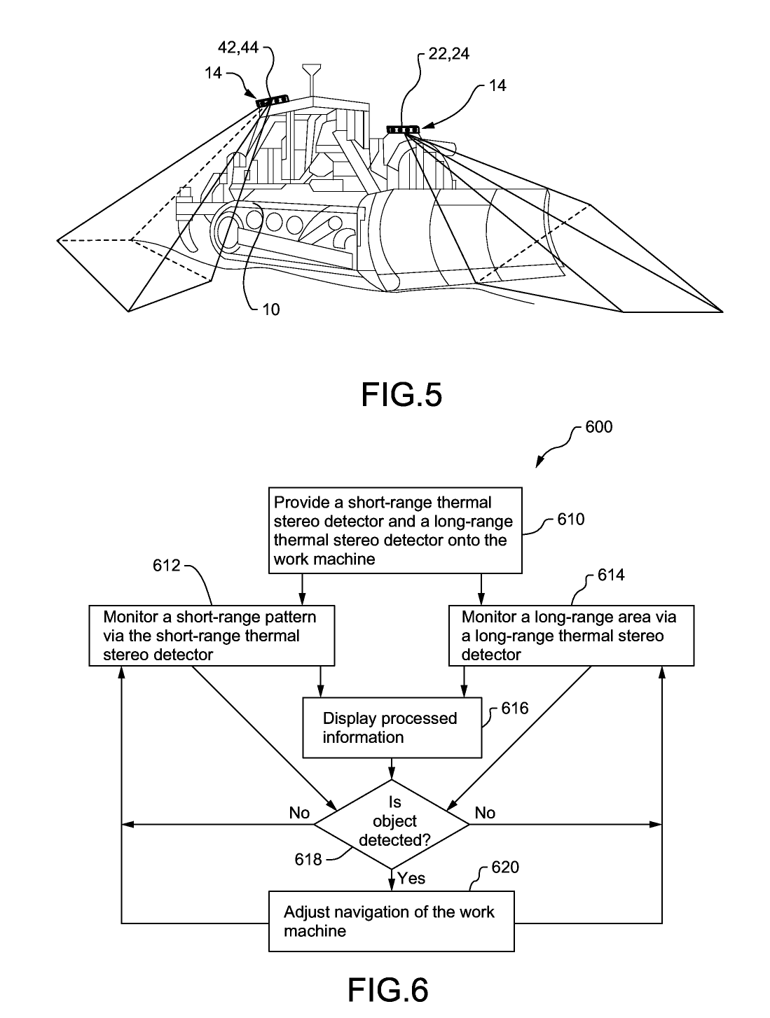

In an alternative embodiment depicted in FIG. 5, the detection system 14 further includes a second short-range thermal stereo detector 42 paired with a second long-range thermal stereo detector 44. With the at least one short-range thermal stereo detector 22 and the at least one long-range thermal stereo detector 24 mounted on a forward section of the work machine 10 (illustrated as an excavator), the second short-range thermal stereo detector 42 and the second long-range thermal stereo detector 44 may be mounted on an aft section of the work machine 10 to provide a surrounding view.

### INDUSTRIAL APPLICABILITY

In operation, the present disclosure may find applicability in many industries including, but not limited to, earthmoving equipment and perception systems for same. For example, with the work machine 10 generally operating in ill-structured, off-road environments, and often times in harsh, low-light conditions, the detection system 14 of the perception system 12 may, despite such environments and conditions, perceive uneven ground surfaces and detect objects thereon thermally and in stereo. Additionally, the detection system 14 may perceive and detect, in stereo and thermally, both short ranges and long ranges.

As one detailed example, the work machine 10 may be a large mining truck, as illustrated in FIG. 1, that travels at high speeds on substantially flat terrain to reach a work site. While navigating these roads at high speeds, the at least one long-range thermal stereo detector 24 of the detection system 14 may monitor and detect, within the long-range area pattern 40, on-coming changes in the path of the road and objects that may already be in the road or happen to move onto the road. The controller 16 receives and processes the monitored information from the at least one long-range thermal stereo detector 24 to display on the output device 18 for aiding an operator in navigating the work machine 10. Alternatively, with the work machine 10 operating autonomously or semi-autonomously, the controller 16 may receive and process the monitored information from the at least one long-range thermal stereo detector 24 to automatically control the work machine components 20, such as but not limited to, steering, brakes, transmission, engine, and the like, for navigating the road and avoiding objects based on the monitored information. Due to the thermal stereo detection of the at least one long-range thermal stereo detector 24, the detection system 14 may perceive and detect the ground surface and objects thereon even through poor visibility conditions caused by dust, fog, rain, snow, or low illumination, as a result of the long wavelength electromagnetic wave detection feature of the detection system 14 bypassing the small particles of such poor visibility conditions.

Furthermore, the work machine 10 may operate at slower speeds within the work site such that the at least one short-range thermal stereo detector 22 of the detection system 14 may monitor and detect, within the short-range area pattern 38, a wide field of view to particularly perceive and detect uneven terrain and surrounding objects such as other machines and personnel due to temperature differences perceived. The controller 16 receives and processes the monitored information from the at least one short-range thermal stereo detector 22 to display on the output device 18 for aiding an operator in navigating the work machine 10. Alternatively, with the work machine 10 operating autonomously or semi-autonomously, the controller 16 may receive and process the monitored information from the at least one short-range thermal stereo detector 22 to automatically control the work machine components 20, such as but not limited to, steering, brakes, transmission, engine, and the like, for navigating the uneven terrain and avoiding objects at the work site based on the monitored information. Due to the thermal stereo detection of the at least one short-range thermal stereo detector 22, the detection system 14 may perceive and detect the ground surface and objects thereon even through poor visibility conditions caused by dust, fog, rain, snow, or low illumination, as a result of the long wavelength electromagnetic wave detection feature of the detection system 14 bypassing the small particles of such poor visibility conditions.

As illustrated in the alternative embodiment of FIG. 5, the detection system 14 may further include the second short-range thermal stereo detector 42 paired with the second long-range thermal stereo detector 44 such that the detection system 14 may perceive and detect a wider surrounding view of the work site as a result of the second short-range thermal stereo detector 42 and the second long-range thermal stereo detector 44 being disposed in an area on the work machine that faces an opposite direction than from the at least one short-range thermal stereo detector 22 and the at least one long-range thermal stereo detector 24. As such, this arrangement is particularly useful for the work machine 10, such as, but not limited to, excavators and dozers, when operating in back and forth movements at the work site.

FIG. 6 illustrates a flow chart 600 of a sample sequence of steps which may be performed for a work machine to perceive and detect, in poor visibility conditions, short-range and long-range environments. Box 610 illustrates the step of providing a short-range thermal stereo detector and a long-range thermal stereo detector onto the work machine. Another step, as illustrated in box 612, may be monitoring a short-range area pattern via the short-range thermal stereo detector. As illustrated in box 614, yet another step may be monitoring a long-range area pattern via the long-range thermal stereo detector. The processed information monitored by the short-range thermal stereo detector and the long-range thermal stereo detector may be displayed, as illustrated in box 616. At decision box 618, it is determined whether an object or uneven terrain has been detected. If no object has been detected, then the short-range thermal stereo detector and the long-range thermal stereo detector may continue monitoring. If an object or uneven terrain has been detected, then an even further step, as illustrated in box 620, may be adjusting the navigation of the work machine to avoid the object or maneuver on the uneven terrain. Adjusting the navigation of the work machine may be achieved manually by an operator or may be achieved autonomously via the controller automatically controlling components of the work machine based on processed information monitored by the short-range thermal stereo detector and the long-range thermal stereo detector. Once adjustments have been made, the short-range thermal stereo detector and the long-range thermal stereo detector may continue monitoring.

What is claimed is:

1. A perception system for a work machine, the perception system comprising:
a short-range thermal stereo detector mounted to the work machine;
a long-range thermal stereo detector mounted to the work machine and facing in the same direction as the short-range thermal stereo detector; and
a controller associated with the short-range thermal stereo detector and the long-range thermal stereo detector, the controller configured to receive information from both the short-range thermal stereo detector and the long-range thermal stereo detector and configured to process the information for one of displaying on an output device of the work machine and automatically controlling, based on the information processed, components mechanically associated with the work machine.

2. The perception system of claim 1, wherein the short-range thermal stereo detector includes a first short-range thermal sensor and a second short-range thermal sensor and the long-range thermal stereo detector includes a first long-range thermal sensor and a second long-range thermal sensor.

3. The perception system of claim 2, wherein the first short-range thermal sensor is horizontally spaced apart from the second short-range thermal sensor by a predetermined short-range stereo baseline and the first long-range thermal sensor is horizontally spaced apart from the second long-range thermal sensor by a predetermined long-range stereo baseline.

4. The perception system of claim 3, wherein the predetermined short-range stereo baseline is 10 centimeters or less and the predetermined long-range stereo baseline is 10 centimeters or greater.

5. The perception system of claim 1, wherein the short-range thermal stereo detector monitors a short-range area pattern and the long-range thermal stereo detector monitors a long-range area pattern.

6. The perception system of claim 5, wherein the short-range area pattern is in a first perception range of one meter to 20 meters away from the work machine and the long-range area pattern is in a second perception range of 20 meters to 80 meters away from the work machine.

7. The perception system of claim 1, wherein the components are one of a steering device, brakes, a transmission, and an engine.

8. A work machine, the work machine comprising:
a detection system mounted to the work machine, the detection system including a short-range thermal stereo detector paired with a long-range thermal stereo detector;
components mechanically associated with the work machine; and
a controller associated with the detection system and the components, the controller configured to receive information from both the short-range thermal stereo detector and the long-range thermal stereo detector and configured to process the information for one of displaying on an output device of the work machine and automatically controlling the components based on the information processed.

9. The work machine of claim 8, wherein the short-range thermal stereo detector includes a first short-range thermal sensor horizontally spaced apart from a second short-range thermal sensor by a predetermined short-range stereo baseline and the long-range thermal stereo detector includes a first long-range thermal sensor horizontally spaced apart from a second long-range thermal sensor by a predetermined long-range stereo baseline.

10. The work machine of claim 9, wherein the first and the second short-range thermal sensors and the first and the second long-range thermal sensors are thermal cameras.

11. The work machine of claim 9, wherein the predetermined short-range stereo baseline is 10 centimeters or less and the predetermined long-range stereo baseline is 10 centimeters or greater.

12. The work machine of claim 8, wherein the detection system further includes a second short-range thermal stereo detector paired with a second long-range thermal stereo detector.

13. The work machine of claim 12, wherein the second short-range thermal stereo detector and the second long-range thermal stereo detector are disposed on an area of the work machine that faces an opposite direction than from the short-range thermal stereo detector and the long-range thermal stereo detector.

14. The work machine of claim 8, wherein the detection system is configured to monitor and detect through poor visibility conditions.

15. The work machine of claim 8, wherein the short-range thermal stereo detector monitors a short-range area pattern and the long-range thermal stereo detector monitors a long-range area pattern.

16. The work machine of claim 15, wherein the short-range area pattern is in a first perception range of one meter to 20 meters away from the work machine and the long-range area pattern is in a second perception range of 20 meters to 80 meters away from the work machine.

17. The work machine of claim 8, wherein the components are one of a steering device, brakes, a transmission, and an engine.

18. A method for a work machine to perceive and detect, in poor visibility conditions, short-range and long-range environments, the method comprising:
providing a short-range thermal stereo detector and a long-range thermal stereo detector onto the work machine;
monitoring a short-range area pattern via the short-range thermal stereo detector; and
monitoring a long-range area pattern via the long-range thermal stereo detector.

19. The method of claim 18, further including displaying processed information monitored by the short-range thermal stereo detector and the long-range thermal stereo detector.

20. The method of claim 18, further including controlling components of the work machine based on processed information monitored by the short-range thermal stereo detector and the long-range thermal stereo detector.
